(19) United States
(12) Patent Application Publication
(10) Pub. No.: US 2025/0259090 A1
(43) Pub. Date: Aug. 14, 2025

(54) Wave-Induced Collapse Systems and Observer Interference Framework for Resolving Foundational Quantum Paradoxes

(71) Applicant: Larry Lim Kheng Cheong, Singapore (SG)

(72) Inventor: Larry Lim Kheng Cheong, Singapore (SG)

(21) Appl. No.: 19/178,991

(22) Filed: Apr. 15, 2025

Related U.S. Application Data
(63) Continuation-in-part of application No. 19/173,849, filed on Apr. 9, 2025.

(51) Int. Cl. G06N 10/40

(52) U.S. Cl. CPC G06N 10/40

(57) ABSTRACT

This Continuation-in-Part extends the wave-interference-based collapse model first proposed in the Modified Schrödinger Equation (MSE) framework to five foundational quantum phenomena: tunneling, entanglement, measurement collapse, time asymmetry, and the resolution of Many-Worlds interpretations. The invention models collapse as a physical consequence of interference between the observer wave and the quantum system wavefunction, characterized by a curvature-based localization mechanism. This framework enables tunable collapse control, non-binary measurement outcomes, and outcome selection through engineered interference, providing a unified physical mechanism with broad technological applications.

### FIELD OF THE INVENTION

The present invention relates to quantum mechanics, and more specifically, to systems and methods for wavefunction collapse through wave-to-wave interference. It extends to applications in quantum tunneling, quantum entanglement, measurement theory, time symmetry violation, and collapse-based interpretations of quantum reality.

### BACKGROUND OF THE INVENTION

Conventional quantum mechanics treats wavefunction collapse as a postulated effect of measurement, lacking a defined physical mechanism. Wave-particle duality, the measurement problem, time-reversibility inconsistencies, and interpretation divergences such as the Many-Worlds hypothesis all stem from this theoretical gap.

The inventor's previous patent introduced a Modified Schrödinger Equation (MSE), in which collapse emerges from physical interference between an observer wave and the quantum system. Collapse is defined by the localization of the wavefunction, indicated by a sharply increasing second derivative curvature, denoted as Ψₚⁿ(t).

This CIP proposes new applications of the MSE model to five long-standing quantum paradoxes. It describes physical systems, devices, and control protocols that apply observer-induced interference to manipulate collapse in ways that solve or bypass traditional paradoxes.

### SUMMARY OF THE INVENTION

This invention introduces five system models based on the Modified Schrödinger Equation (MSE) wave-interference collapse framework. Each model addresses a major unresolved phenomenon in quantum theory using a consistent physical mechanism of collapse based on interference convergence and wavefunction curvature:
1. Tunneling Collapse System—Observer interference induces collapse, controlling tunneling probability and timing based on Ψₚⁿ(t).
2. Entanglement Collapse Synchronizer—Phase-synchronized observer waves cause simultaneous collapse of entangled wavefunctions.
3. Measurement via Convergence—Measurement as continuous and tunable, governed by interference intensity and curvature, not binary collapse.
4. Collapse-Driven Time Asymmetry System—p ₚⁿ(t) threshold introduces temporal irreversibility, defining the arrow of time.
5. Collapse-Only Outcome Selector—Destructive interference cancels alternate quantum paths, selecting a single observed outcome without branching.

These models reinterpret and enable control over quantum collapse across both theoretical and technological platforms.

### DETAILED DESCRIPTION OF THE INVENTION

The invention's five models rely on physical collapse through interference. The Modified Schrödinger Equation introduces a curvature-driven collapse trigger, where Ψₚⁿ(t) reflects localization.

### General Principles

Collapse occurs when interference between Ψₒ(t) and Ψₚ(t) causes Ψₚⁿ(t) to exceed a threshold.
Observer waves may be electromagnetic, acoustic, or simulated photonic patterns.
Collapse is tunable—affected by amplitude, phase, coherence, and angle of Ψₒ(t).
Systems may be configured for:
   Tunneling control
   Entanglement synchronization
   Graded measurement
   Time-asymmetric simulation
   Outcome selection

### Appendix A: Tunneling Reinterpreted

Collapse causes particle to localize beyond a potential barrier.
Collapse triggered when Ψₚⁿ(t)>δ due to interference with Ψₒ(t).
Predictive model replaces probabilistic tunneling with curvature-based event.

### Appendix B: Entanglement Redefined

Collapse only occurs if Ψₒ(t) overlaps with both entangled particles.
Defines convergence functional:

$$C ( t ) = \int {\vert {Ψ}_{o} ( {x}_{1} ) {Ψ}_{p 1} ( {x}_{1} ) + {Ψ}_{o} ( {x}_{2} ) {Ψ}_{p 2} ( {x}_{2} ) \vert}^{2} d x$$

Collapse occurs when:

$$\frac{{d}^{2} C ( t )}{d {t}^{2}} > δ$$

### Appendix C: Measurement Reinterpreted

Measurement is a gradual process, not instantaneous.
Collapse strength depends on Ψₒ-Ψₚ interaction.
Models partial collapse and reversible probing:

$${Ψ}_{p}^{″} ( t ) = \frac{{d}^{2}}{d {t}^{2}} \int {\vert {Ψ}_{p} ( t , x ) \vert}^{2} d x > δ$$

### Appendix D: Time Asymmetry via Collapse

Collapse marks break in time symmetry.
Curvature spike in Ψₚⁿ(t) introduces irreversible direction:

$${Ψ}_{p}^{″} ( t ) \neq {Ψ}_{p}^{″} ( - t )$$

Collapse represents thermodynamic arrow of time in quantum domain.

### Appendix E: Many-Worlds Collapsed

Collapse happens by destructive interference, not universe branching.
Observer wave Ψₒ(t) selects a path:

$${Ψ}_{p} ( t ) = \sum {α}_{i} {ψ}_{i} ( t ) {Γ}_{i} ( t ) = \int {\vert {Ψ}_{o} ( t , x ) {ψ}_{i} ( t , x ) \vert}^{2} d x$$

Collapse when:

$$\frac{{d}^{2} {Γ}_{k} ( t )}{d {t}^{2}} > δ , {Γ}_{j} ( t ) < ∈ for j \neq k$$

1. Tunneling Control via Collapse Curvature An apparatus comprising:
(a) a quantum system with a defined potential barrier;
(b) an observer interference field configured to interact with the wavefunction of the quantum system; and
(c) a monitoring module that tracks the second derivative curvature of the wavefunction, Ψₚⁿ(t),
wherein the tunneling probability of the quantum system is modulated via collapse triggered by interference-induced curvature exceeding a defined threshold.

2. Entanglement Collapse via Observer Convergence A system comprising:
(a) at least two entangled particles;
(b) synchronized observer waves directed toward each particle; and
(c) an interference energy density detector,
wherein the system triggers simultaneous collapse of the entangled particles when convergence of observer wave interference meets or exceeds a specified energy threshold.

3. Measurement via Interference Thresholding A method of quantum measurement comprising:
(a) providing an observer wave to interfere with a quantum wavefunction;
(b) monitoring the curvature Ψₚⁿ(t) of the system; and
(c) defining measurement collapse as a continuous, tunable process governed by the magnitude of interference and resulting curvature threshold.

4. Time Asymmetry from Collapse Dynamics A quantum simulation system comprising:
(a) a bidirectional, time-reversible wavefunction; and
(b) a curvature-based collapse trigger configured to induce temporal irreversibility, wherein the discontinuity in Ψₚⁿ(t) indicates a collapse event that defines the arrow of time.

5. Collapse-Based Outcome Selection Device A quantum outcome selection device comprising:
(a) a quantum system with multiple branching evolution paths; and
(b) a destructive interference mechanism configured to cancel alternate wavefunction paths,
wherein collapse occurs at the path with maximal constructive overlap, resulting in a single observed outcome.
Dependent Subclaims:
1. The observer field is configured as a pulsed electromagnetic source.
2. Collapse is defined by the condition Ψₚⁿ(t)>3σ, where σ is the standard curvature deviation of the system.
3. Entanglement synchronization is achieved via photon-pair interactions using a coherent laser source.
4. The destructive interference mechanism utilizes holographic phase-canceling interference patterns.
5. The system allows for partial or reversible measurement when Ψₚⁿ(t) is sub-threshold.
